(19) United States
(12) Patent Application Publication
(10) Pub. No.: US 2016/0364892 A1
(43) Pub. Date: Dec. 15, 2016

(54) FONT DEFORMATION METHOD BY CHANGING DIMENSIONS OF AT LEAST ONE PARTITION OF A FRAME SURROUNDING A CHARACTER

(71) Applicant: ARPHIC TECHNOLOGY CO., LTD., New Taipei City (TW)

(72) Inventors: Yi-Hui Huang, New Taipei City (TW); Fu-Sheng Wu, New Taipei City (TW)

(21) Appl. No.: 15/175,051

(22) Filed: Jun. 7, 2016

(30) Foreign Application Priority Data
Jun. 10, 2015 (TW) 104118676

(51) Int. Cl. G06T 11/60; G06T 7/00; G06K 9/00; G06K 9/52; G06T 5/00; G06T 3/40; G06K 9/62; G06T 7/60; G06T 3/00; G06T 11/20

(52) U.S. Cl. CPC G06T 11/60; G06T 3/0093; G06T 7/0079; G06K 9/00442; G06T 11/20; G06T 5/00; G06T 3/40; G06K 9/6267; G06T 7/60; G06K 9/52; G06T 2207/20021

(57) ABSTRACT

A font deformation method includes surrounding a character with a frame, where the outline of the character has a plurality of control points used for describing the outline of the character; using a set of partitioning lines to divide the frame into a plurality of partitions, the set of partitioning lines separating the character into a plurality of character portions each being corresponding to a partition; determining corresponding coordinates of each control point in its corresponding partition; moving the set of partitioning lines to change the dimension of some partitions; adjusting at least one control point to keep corresponding coordinates of each control point substantially unchanged in its corresponding partition; and drawing a deformed outline according to the plurality of adjusted control points to generate a deformed character.

### CROSS REFERENCE TO RELATED APPLICATION

This application claims priority to Taiwan Patent Application No. 104118676, filed Jun. 10, 2015, and incorporated herein by reference in its entirety.

### BACKGROUND OF THE INVENTION

1. Field of the Invention

The present invention is related to a font deformation method, and more particularly, a font deformation method by changing ratio of dimensions of portions of a frame surrounding a character.

2. Description of the Prior Art

According to the prior art, when a font company plans to design an innovative font having different visual effect from the previous fonts, considerable research and design resources will be required. For example, when designing a new Chinese font, around six thousand often used characters or even more than ten thousand characters have to be built. Take the font “PMingLiU” as an example, it has included 70195 Chinese characters after several updates. If creating such a great number of characters from scratch, the develop time will be even longer and a great amount of manual processing is unavoidable, amounting to humongous time and cost. Furthermore, storing multiple sets of font with various artistic effects at a user terminal (e.g. a smart phone or a personal computer) or a server terminal (e.g. a cloud host server) would require a lot of memory space. Hence, a solution to generate various fonts with different artistic effects is required to meet the demand of font designers and users.

### SUMMARY OF THE INVENTION

An embodiment of the present invention provides a font deformation method. The font deformation method includes surrounding a character with a frame, wherein an outline of the character has a plurality of control points configured to define the outline of the character; using a set of partitioning lines to divide the frame into a plurality of partitions, the set of partitioning lines separating the character into a plurality of character portions each being corresponding to a partition; determining corresponding coordinates of each control point in its corresponding partition; moving the set of partitioning lines to change dimensions of some of the partitions; adjusting at least one control point to keep corresponding coordinates of each control point substantially unchanged in its corresponding partition; drawing a deformed outline according to a plurality of adjusted control points to generate a deformed character; and displaying the deformed character on a display panel.

Another embodiment of the present invention provides a font deformation method. The font deformation method includes surrounding a character by using a frame, wherein the character has a set of strokes, and each of the strokes has at least a key point so that the character comprises a set of key points; using a set of partitioning lines to divide the frame into a plurality of partitions so that each key point is corresponding to a partition; determining corresponding coordinates of each key point in its corresponding partition; moving the set of partitioning lines to change dimensions of some of the partitions; adjusting at least one key point to keep corresponding coordinates of each key point substantially unchanged in its corresponding partition; drawing a set of adjusted strokes according to the set of adjusted key points; generating a deformed character according the set of adjusted strokes; and displaying the deformed character on a display panel.

Yet another embodiment of the present invention provides a font deformation method. The font deformation method includes surrounding a character by using a frame, the character having a set of bitmap pixels; using a set of partitioning lines to divide the frame into a plurality of partitions so that each bitmap pixel is corresponding to a partition; determining corresponding coordinates of each bitmap pixel in its corresponding partition; moving the set of partitioning lines to change dimensions of some of the partitions; adjusting at least one bitmap pixel of the set of bitmap pixels to keep the coordinates of each bitmap pixel substantially unchanged in its corresponding partition; generating a deformed character according to a set of adjusted bitmap pixels; and displaying the deformed character on a display panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an undeformed character according to the first embodiment of the present invention.

FIG. 2 illustrates a deformed character according to the first embodiment of the present invention.

FIG. 3 illustrates visual effect before and after performing the font deformation method according to the first embodiment of the present invention.

FIGS. 4-5 illustrate an undeformed character, a corresponding deformed character, and the movement of a set of first partitioning lines and a set of second partitioning lines when performing a multiple-centroids font deformation according to an embodiment of the present invention.

FIG. 6 illustrates a Bezier curve used to define a segment in the embodiment of the present invention.

FIG. 7 illustrates a flowchart of a font deformation method according to the first embodiment of the present invention.

FIG. 8 illustrates an undeformed character according to the second embodiment of the present invention.

FIG. 9 illustrates a deformed character according to the second embodiment of the present invention.

FIG. 10 illustrates the structure of the character of FIGS. 8-9 and the combination of the strokes of the character.

FIG. 11 illustrates stroke width parameters and key points of a stroke according to the second embodiment of the present invention.

FIG. 12 illustrates a flowchart of a font deformation method according to the second embodiment of the present invention.

FIG. 13 illustrates an undeformed character according to the third embodiment of the present invention.

FIG. 14 illustrates a deformed character according to the third embodiment of the present invention.

FIGS. 15-16 illustrate adjustment of grey-level values of bitmap pixels of a deformed character according to the third embodiment of the present invention.

FIG. 17 illustrates a flowchart of a font deformation method according to the third embodiment of the present invention.

FIG. 18 illustrates four plans of partitions and partitioning line as examples according to embodiments of the present invention.

FIG. 19 illustrates visual effects of deforming a set of Latin characters according to an embodiment of the present invention.

FIG. 20 illustrates an approach to set asymmetric coordinate systems in partitions according to an embodiment of the present invention.

FIG. 21 illustrates a system corresponding to a font deformation method provided by an embodiment of the present invention.

### DETAILED DESCRIPTION

### First Embodiment of the Present Invention

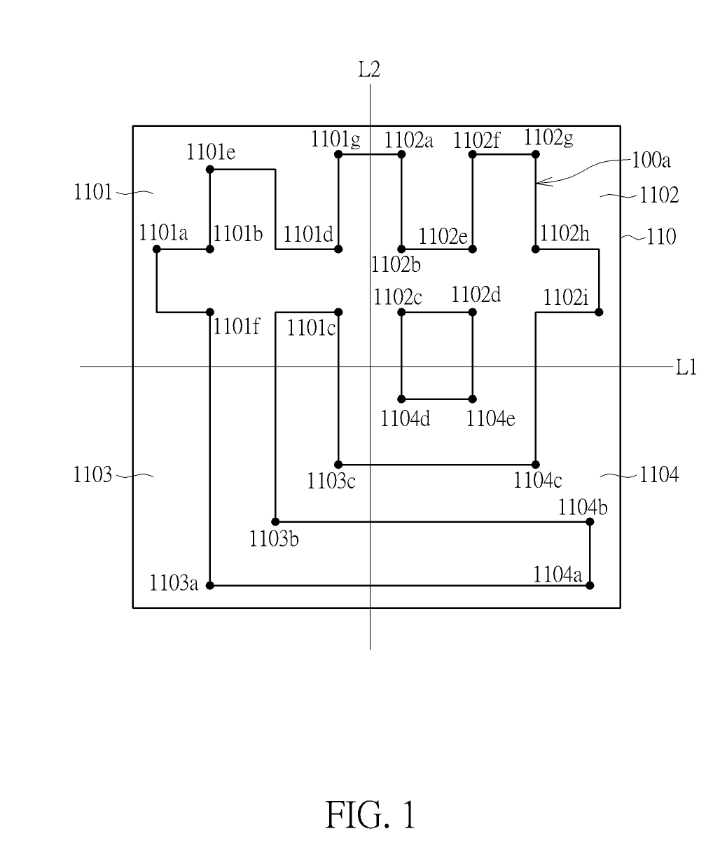

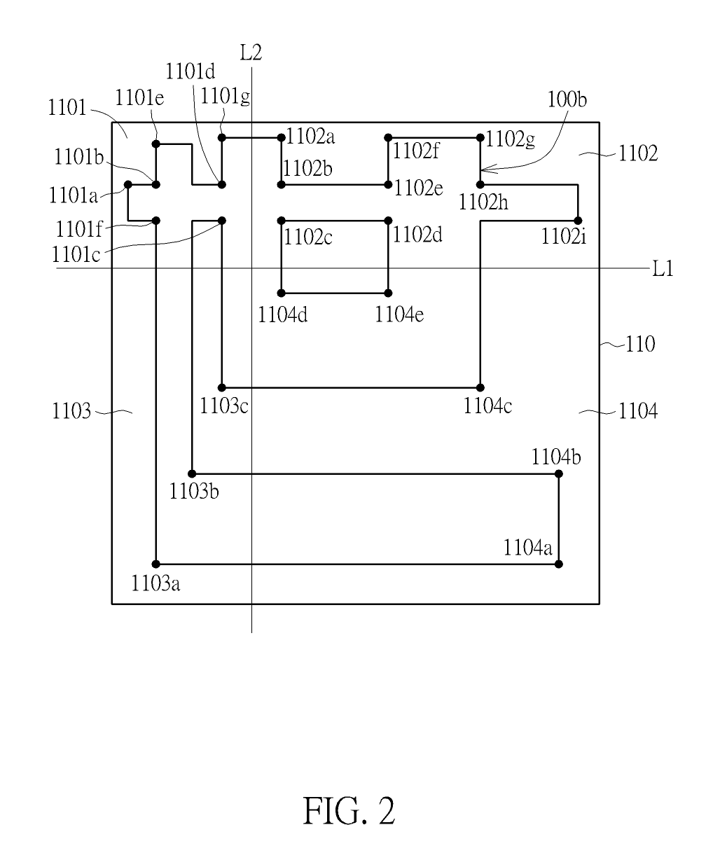

FIG. 1 illustrates an undeformed character 100a according to the first embodiment of the present invention. FIG. 2 illustrates a deformed character 100b according to the first embodiment of the present invention. The deformed character 100b may be obtained by deforming the character 100a. In the example of FIGS. 1-2, a Chinese character “ [symbol] ” (corresponding to a Unicode code “U+4E16”) is merely used to explain the method provided by the embodiment of the present invention instead of limiting the scope the present invention.

In FIG. 1, a frame 110 may surround the character 110a. A set of partitioning lines such as a first partitioning line L1 and a second partitioning line L2 may divide the frame 110 into a plurality of partitions 1101, 1102, 1103 and 1104. The first partitioning line L1 and the second partitioning line L2 may also separate the character 110a into a plurality of character portions. In FIG. 1, the character “ [symbol] ” is separated into four character portions. Each character portion may correspond to one of the partitions 1101-1104. An outline of the character 100a may include a plurality of control points used to define the outline of the character 100a. For example, the control points may be turning points of the outline or act as control points of Bezier curves. After dividing the frame with the partitioning lines, each control point may correspond to a partition as described in table-1:

TABLE 1

| | Corresponding control points on the |
|---|---|
| | outline of the character portion in the |
| partition | partition |
| 1101 | 1101a, 1101b, 1101c, 1101d, 1101f, |
| | 1101g |
| 1102 | 1102a, 1102b, 1102c, 1102d, 1102e, |
| | 1102f, 1102g, 1102h, 1102i |
| 1103 | 1103a, 1103b, 1103c |
| 1104 | 1104a, 1104b, 1104c, 1104d, 1104e |

Corresponding coordinates of each control point may be fixed in its corresponding partition before and after the partitions 1101-1104 are updated. For example, suppose the position of the control point 1101a is 8% from the left side of the frame 110 to the partitioning line L2, and 41% from the partitioning line L1 to the upper side of the frame 110 before the partitions 1101-1104 are updated as shown in FIG. 1. After the first partitioning line L1 is moved upward, and the second partitioning line L2 is moved leftward to update the partitions 1101-1104, the position of the control point 1101a is still approximately 8% from the left side of the frame 110 to the partitioning line L2, and approximately 41% from the partitioning line L1 to the upper side of the frame 110 as shown in FIG. 2. Thus the positions and the dimensions of the partitions 1101-1104 may be changed from what is shown in FIG. 1 to what is shown in FIG. 2. The direction and amount of movement of the partitioning lines L1 and L2 may be used as example, and a user may decide appropriate setting of movement according to demand. As shown in FIG. 2, the positions and dimensions of partitions 1101-1104 may be changed according to the movement of the partitioning lines L1 and L2, and then the control points 1101a-1101g, 1102a-1102i, 1103a-1103c and 1104a-1104e may be adjusted to keep corresponding coordinates of each control point substantially unchanged in its corresponding partition. As shown in FIG. 2, a deformed character 100b may be generated by drawing a deformed outline according to a plurality of adjusted control points 1101a-1101g, 1102a-1102i, 1103a-1103c and 1104a-1104e. The deformed character 100b may be displayed on a display panel or for other usages such as being printed. According to the first embodiment of the invention, a selected control point may be (but not limited to) a turning point of the character outline, a point on a segment of the character outline, or one of a set of control points defining a Bezier curve.

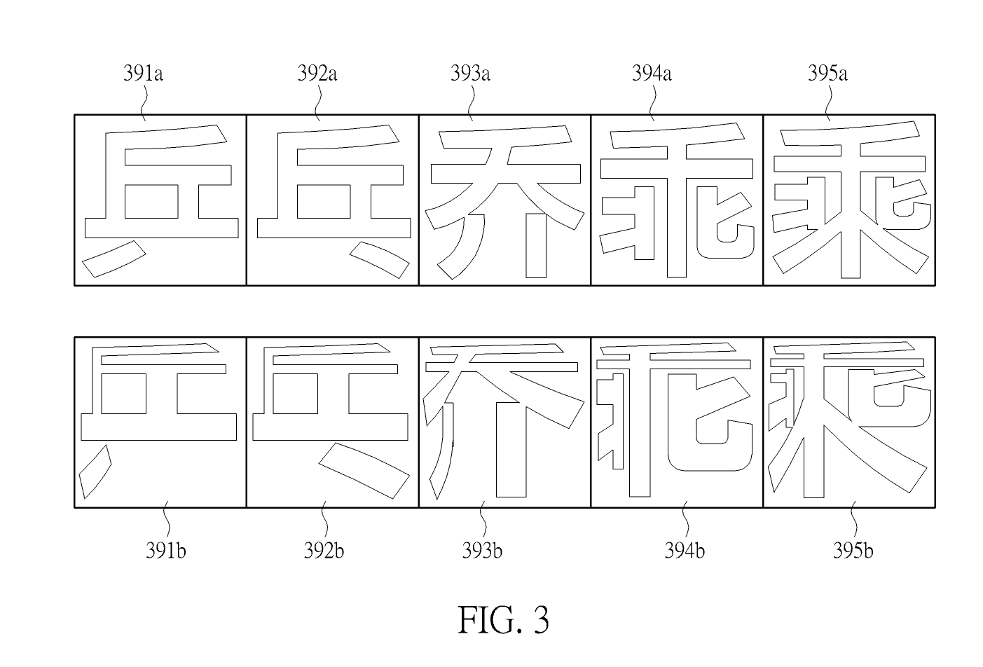

FIG. 3 illustrates visual effect of performing the font deformation method according to the first embodiment of the present invention. The characters 391a-395a may be undeformed characters, and the characters 391b-395b may be deformed characters. Since the control points may locate at the outlines of the characters, the strokes of the deformed characters may be made thicker or thinner depending on moving directions of partitioning lines, thereby creating desirable artistic effects.

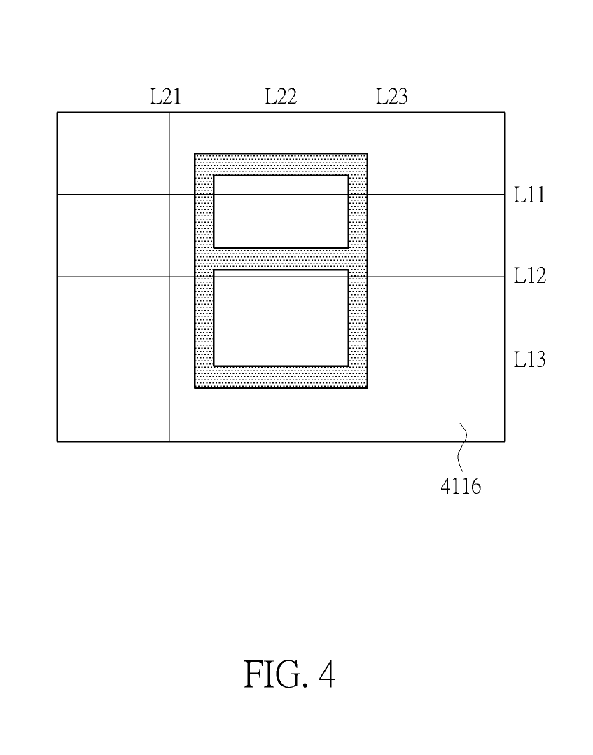

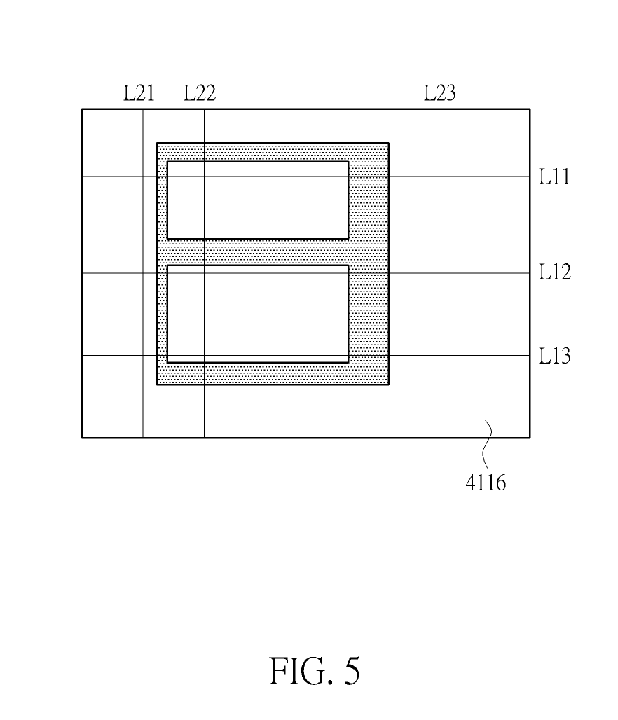

In the example shown in FIGS. 1-2, each of the first partitioning line L1 and the second partitioning line L2 is a single partitioning line. According to an embodiment of the present invention, a user may use a set of first partitioning lines and a set of second partitioning lines to divide the frame 110 into a greater number of partitions. Each of the intersections of the set of first partitioning lines and the set of second partitioning lines may be regarded as a centroid of the character. When deforming the character 100a to generate the deformed character 100b, a single-centroid font deformation is performed. According to another embodiment of the present invention, a multiple-centroids font deformation may also be supported. FIGS. 4-5 illustrate a character, a corresponding deformed character, and the movement of a set of first partitioning lines L11-L13 and a set of second partitioning lines L21-L23 when performing a multiple-centroids font deformation according to an embodiment of the present invention. A Chinese character “ [symbol] ” (meaning “sun”) is taken as an example instead of limiting the scope of the present invention. Comparing FIG. 5 with FIG. 4, the dimensions of the partitions may be changed, and the character may be deformed when the set of first partitioning lines L11-L13 and the set of second partitioning lines L21-L23 are moved. According to an embodiment, among the set of first partitioning lines and the set of second partitioning lines, not every partitioning line needs to be moved. For example, the first partitioning line L13 and the second partitioning line L23 may remain unmoved, and the location and dimensions of a partition 4116 may be therefore kept intact. The set of first partitioning lines may be disposed horizontally, and the set of second partitioning lines may be disposed vertically.

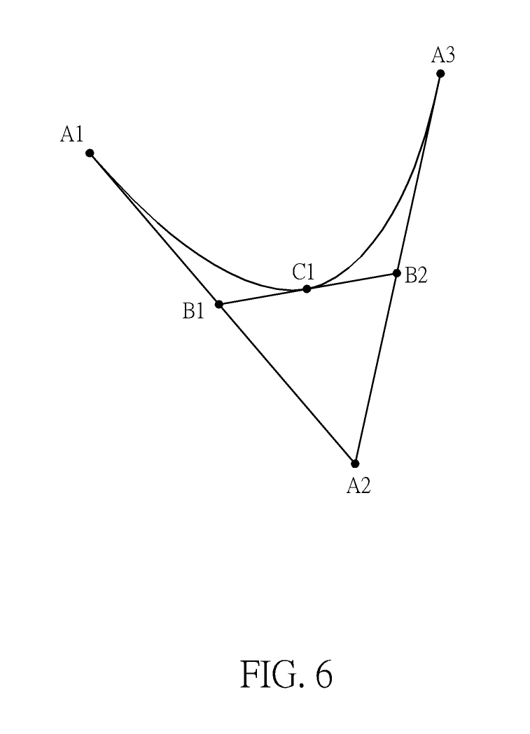

The characters used in the abovementioned examples may be drawn and defined by using the outline, and this kind of character may belong to a vector-font conforming to an outline font format such as TrueType format or OpenType format. The control points may be obtained by selecting the control points of Bezier curves of curved portions of an outline of a character. FIG. 6 illustrates a Bezier curve used to define a curved segment in the embodiment of the present invention. Nodes A1, A2, A3, B1 and B2 may define a plurality of line segments. By adjusting the position and length of the line segments A1-A2, A2-A3 and B1-B2 and the Bezier curve control point C1 appropriately, a suitable curved segment may be obtained. The process of adjusting a curved segment may correspond to a Bezier curve algorithm. After deforming an outline of a character, the Bezier curve algorithm may be utilized to fine tune the deformed outline so as to smoothen the deformed outline and improve the quality of a deformed character according to an embodiment of the present invention.

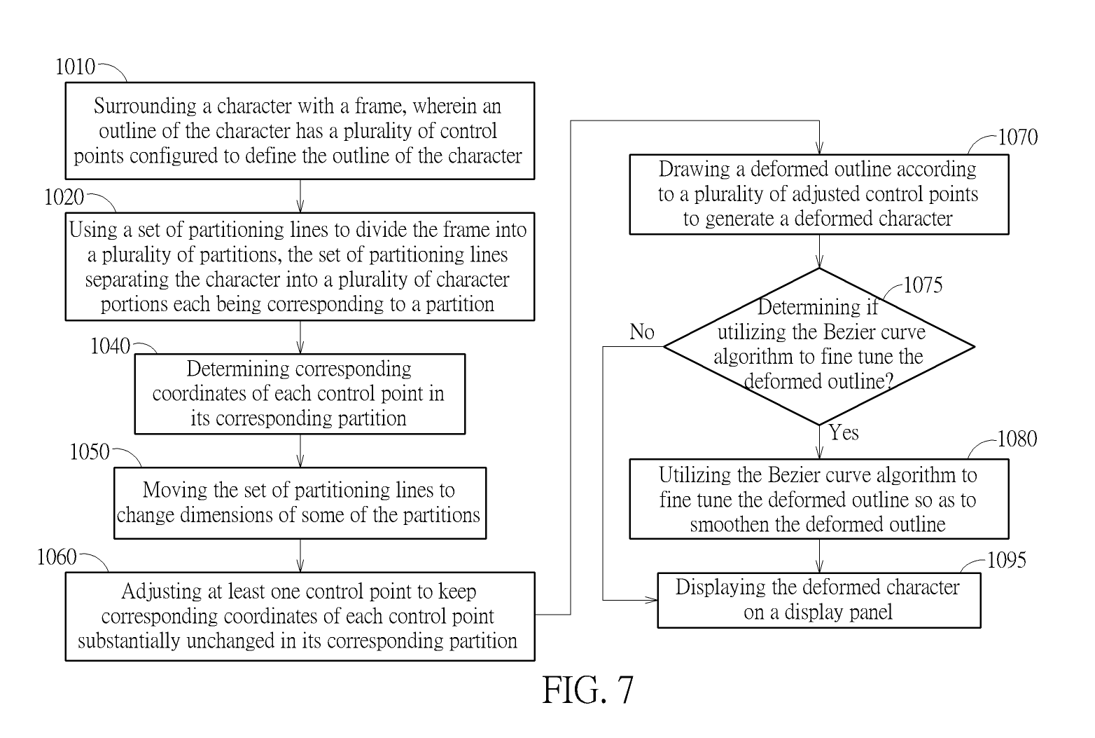

FIG. 7 illustrates a flowchart of a font deformation method 1000 according to the first embodiment of the present invention. The font deformation method 1000 may include the following steps:

Step 1010: surrounding a character with a frame, wherein an outline of the character has a plurality of control points configured to define the outline of the character;

Step 1020: using a set of partitioning lines to divide the frame into a plurality of partitions, the set of partitioning lines separating the character into a plurality of character portions each being corresponding to a partition;

Step 1040: determining corresponding coordinates of each control point in its corresponding partition;

Step 1050: moving the set of partitioning lines to change dimensions of some of the partitions;

Step 1060: adjusting at least one control point to keep corresponding coordinates of each control point substantially unchanged in its corresponding partition;

Step 1070: drawing a deformed outline according to a plurality of adjusted control points to generate a deformed character;

Step 1075: determining if utilizing the Bezier curve algorithm to fine tune the deformed outline? if so, entering step 1080; if not, entering step 1095;

Step 1080: utilizing the Bezier curve algorithm to fine tune the deformed outline so as to smoothen the deformed outline; and

Step 1095: displaying the deformed character on a display panel.

When the quality of the deformed character is acceptable, step 1080 may be skipped. As described above, the adjustable factor of the font deformation method disclosed by the first embodiment of the present invention may be control points of an outline of a character.

### Second Embodiment of the Present Invention

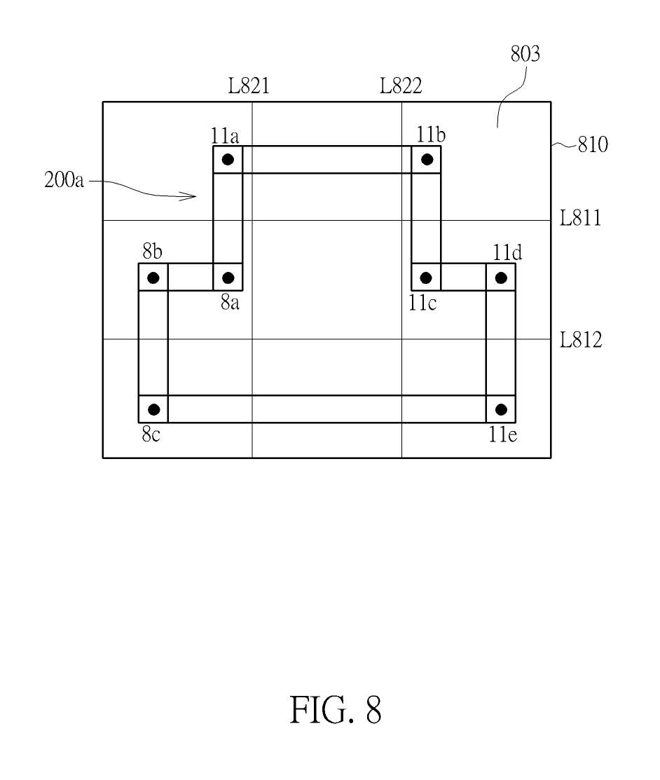

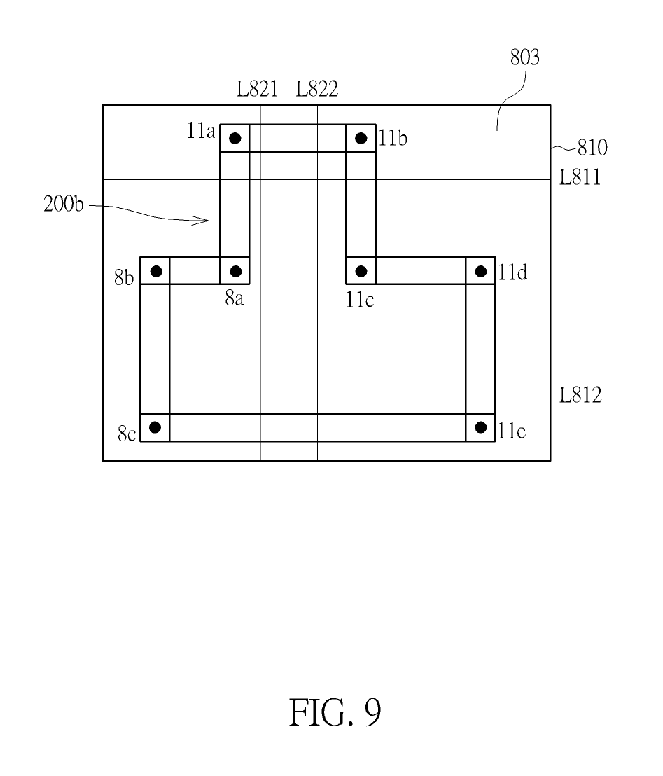

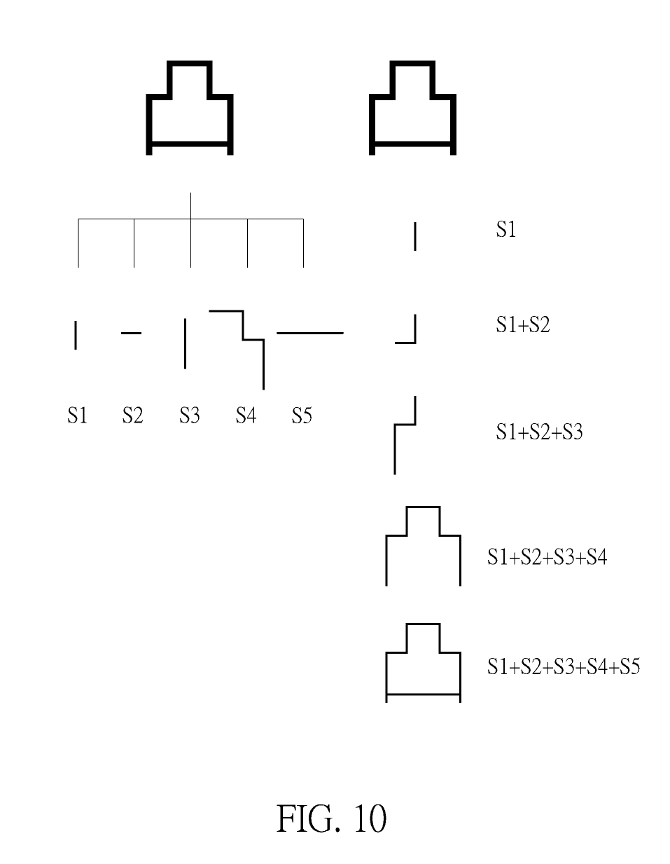

FIG. 8 illustrates an undeformed character 200a according to the second embodiment of the present invention. FIG. 9 illustrates a deformed character 200b according to the second embodiment of the present invention. The deformed character 200b may be obtained by deforming the character 200a. In the example of FIGS. 8-9, a Chinese character “ [symbol] ” (meaning “bulge”) is merely used to explain the method provided by the embodiment of the present invention instead of limiting the scope the present invention. FIG. 10 illustrates the structure of the character “ [symbol] ” and the combination of the strokes of the character. As shown in FIG. 10, the character “ [symbol] ” may be composed of strokes S1, S2, S3, S4 and S5. Unlike the character 100a of FIG. 1, the character 200a of FIG. 8 may be composed of a set of strokes rather than being drawn by using the outline of the character such as the character 100a. That is to say, the character 200a may be obtained by using a stroke composition technique. When a font (e.g. the font “Heiti”) includes i characters, and j kinds of strokes are used to compose the i characters, each character of the font may be described by using table-2 and table-3. The parameters i and j are both positive integers.

TABLE 2

| | | | |
|---|---|---|---|
| The 1ₛₜ | The 1ₛₜ stroke | . . . | The n1ₜₕ stroke |
| character | identification | | identification code |
| (including | code and the 1ₛₜ | | and the n1ₜₕ stroke |
| n1 | stroke parameter | | parameter |
| strokes) | (of the 1ₛₜ | | (of the 1ₛₜ character) |
| | character) | | |
| The 2_{nd} | The 1ₛₜ stroke | . . . | The n2ₜₕ stroke |
| character | identification | | identification code |
| (including | code and the 1ₛₜ | | and the n2ₜₕ stroke |
| n2 | stroke parameter | | parameter |
| strokes) | (of the 2_{nd} | | (of the 2_{nd} character) |
| | character) | | |
| . . . | . . . | . . . | . . . |
| The iₜₕ | The 1ₛₜ stroke | . . . | The niₜₕ stroke |
| character | identification | | identification code |
| (including | code and the 1ₛₜ | | and the niₜₕ stroke |
| ni | stroke parameter | | parameter |
| strokes) | (of the iₜₕ | | (of the iₜₕ character) |
| | character) | | |

Note:
The parameters n1 to ni may be positive integers.

TABLE 3

| | |
|---|---|
| Stroke | Stroke parameters |
| identification | (positions of key points of the stroke, number |
| code = 1 | of the key points, width(s) of the stroke) |
| Stroke | Stroke parameters |
| identification | (positions of key points of the stroke, number |
| code = 2 | of the key points, width(s) of the stroke) |
| . . . | . . . |
| Stroke | Stroke parameters |
| identification | (positions of key points of the stroke, number |
| code = j | of the key points, width(s) of the stroke) |

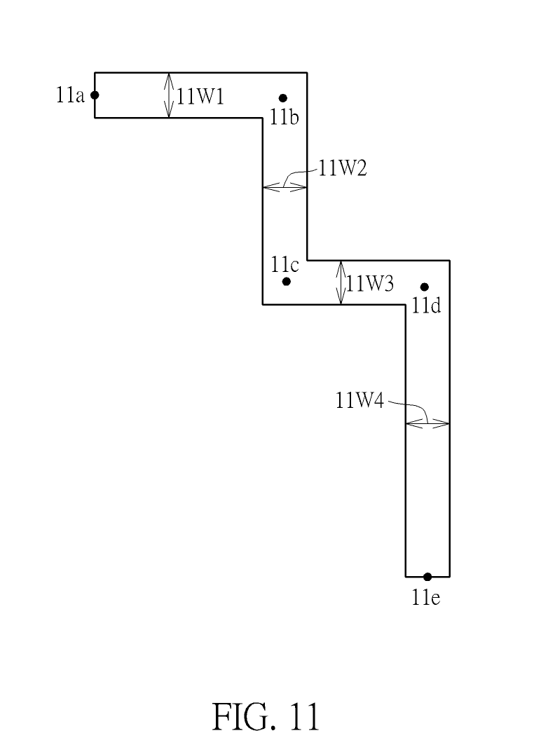

In table-3, the stroke parameters corresponding to a stroke may be used by a program to define the stroke. By describing positions of key points of the stroke, number of the key points and width (s) of the stroke, a stroke may be defined. FIG. 11 illustrates stroke width parameters and key points of a stroke according to the second embodiment of the present invention. The fourth stroke of the character “ [symbol] ”, i.e. “ [symbol] ”, may be used as an example. According to Dictionary of Chinese Character Variant released by Taiwanese Ministry of Education, the stroke may be formally named as “horizontal-turning-horizontal-turning”. In Unicode database, the stroke “ [symbol] ” may also correspond to a Unicode code “U+310E” and a Unicode CJK (China-Japan-Korea) stroke named “HZZZ”. As shown in FIG. 11, the stroke “ [symbol] ” may include five key points 11a, 11b, 11c, 11d and 11e, and four width value 11W1, 11W2, 11W3 and 11W4. The four width values and the positions of the five key points may define the stroke. Similarly, each stroke of the character 200a shown in FIG. 8 may include a set of key points respectively. With different kind of stroke, each kind of stroke may be assigned with a stroke identification code and a set of parameters. The set of parameters may include locations and number of key points, and stoke width parameters.

The concept of deforming the character 200a of FIG. 8 to obtain the character 200b of FIG. 9 may be similar to the method disclosed by the first embodiment of the present invention. According to the font deformation method provided by the second embodiment of the present invention, a frame 810 may be used to surround the character 200a. The character 200a may have a set of strokes such as a vertical stroke S1 “|” with a Unicode code “U+31D1” and a Unicode CJK stroke named “S”, a horizontal stroke S2 “—” with a Unicode code “U+31D0” and a Unicode CJK stroke named “H”, a vertical stroke S3 “|” with a Unicode code “U+31D1” and a Unicode CJK stroke named “S”, a horizontal-turning-horizontal-turning stroke S4 “ [symbol] ” with a Unicode code “U+310E” and a Unicode CJK stroke named “HZZZ”, and a horizontal stroke S5 “—” with a Unicode code“U+31D0” and a Unicode CJK stroke named “H”. Each stroke may include at least one key point so that the character 200a may have a set of key points such as 11a, 11b, 11c, 11d, 11e, 8a, 8b and 8c. A set of partitioning lines, such as a set of first partitioning lines L811 and L812 and a set of second partitioning lines L821 and L822, may be used to divide the frame 810 into a plurality of partitions so that each key point may be positioned inside a corresponding partition. At least one of the set of first partitioning lines L811-L812 and/or the set of second partitioning lines L821-L822 may be moved to change dimensions of some of the partitions. Coordinates of each key point are kept substantially unchanged in its corresponding partition after the partition is deformed. For example, the position of the key point 11b is originally 22% from the second partitioning line L822 to the right side of a partition 803 and 63% from the first partitioning line L811 to the upper side of the partition 803 as shown in FIG. 8. As shown in FIG. 9, after moving the first partitioning line L811 upward and the second partitioning line L822 leftward, the partition 803 is deformed to be narrowed vertically and widened horizontally, and the position of the key point 11b is still approximately 22% from the second partitioning line L822 to the right side of a partition 803 and 63% from the first partitioning line L811 to the upper side of the partition 803. As shown in FIG. 9, a set of adjusted strokes may be drawn according to the set of adjusted key points, and the deformed character 200b may be generated according to the set of adjusted strokes. The deformed character 200b may be displayed on a display panel, and printed by a printer device.

When deforming a character according to an embodiment of the present invention, the shrunk portion of the deformed character may become blurred because a plurality of strokes may overlap one another. The shrunk portion may be deblurred to improve its readability. For example, strokes of the shrunk portion may be reduced, space between the strokes may be widened, and/or stroke widths may be modified. The deblurring process may be done manually or automatically according to an algorithm.

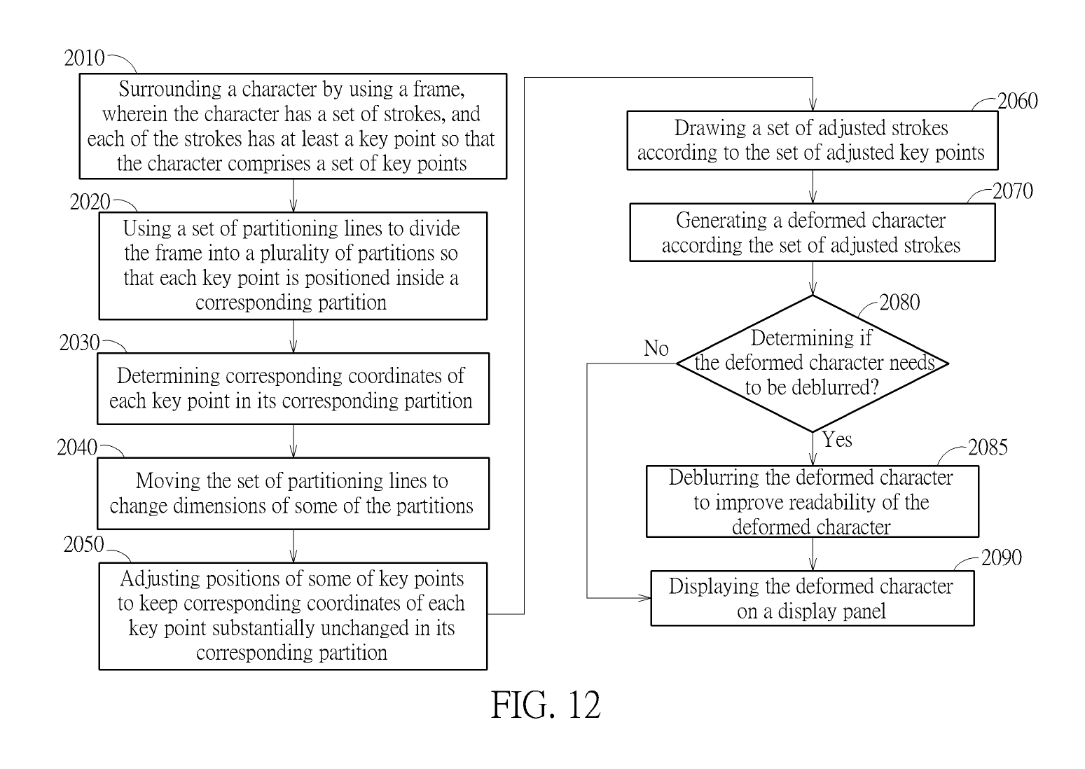

A character composed by a set of strokes may be deformed by a font deformation method provided by the second embodiment of the present invention. A character of a vector font may also be deformed with this approach if the character is analyzed by using a corresponding set of strokes. FIG. 12 illustrates a flowchart of a font deformation method 2000 according to the second embodiment of the present invention. The method 2000 may include the following steps:

Step 2010: surrounding a character by using a frame, wherein the character has a set of strokes, and each of the strokes has at least a key point so that the character comprises a set of key points;

Step 2020: using a set of partitioning lines to divide the frame into a plurality of partitions so that each key point is positioned inside a corresponding partition;

Step 2030: determining corresponding coordinates of each key point in its corresponding partition;

Step 2040: moving the set of partitioning lines to change dimensions of some of the partitions;

Step 2050: adjusting positions of some of key points to keep corresponding coordinates of each key point substantially unchanged in its corresponding partition;

Step 2060: drawing a set of adjusted strokes according to the set of adjusted key points;

Step: 2070: generating a deformed character according the set of adjusted strokes;

Step 2080: determining if the deformed character needs to be deblurred; if so, entering step 2085; if not, entering step 2090;

Step 2085: deblurring the deformed character to improve readability of the deformed character; and

Step 2090: displaying the deformed character on a display panel.

When the quality of the deformed character is acceptable, the step 2085 may be skipped. As mentioned above, the adjustable parameters of the font deformation method disclosed by the second embodiment of the present invention may include a set of positions of the key points and a set of stroke width parameters. In another embodiment, the character may be deformed by adjusting the positions of the key points without changing the stroke width parameters.

### The Third Embodiment of the Present Invention

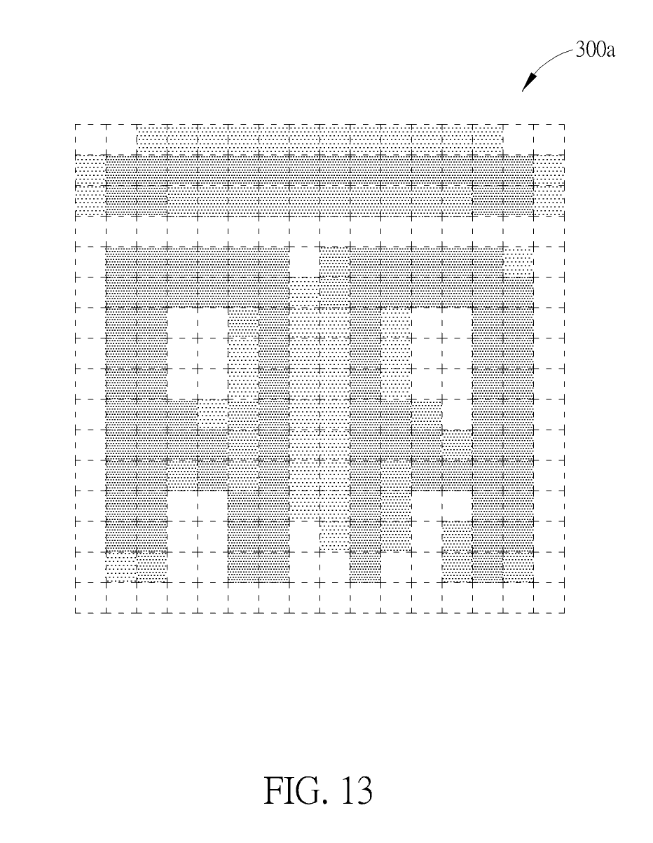

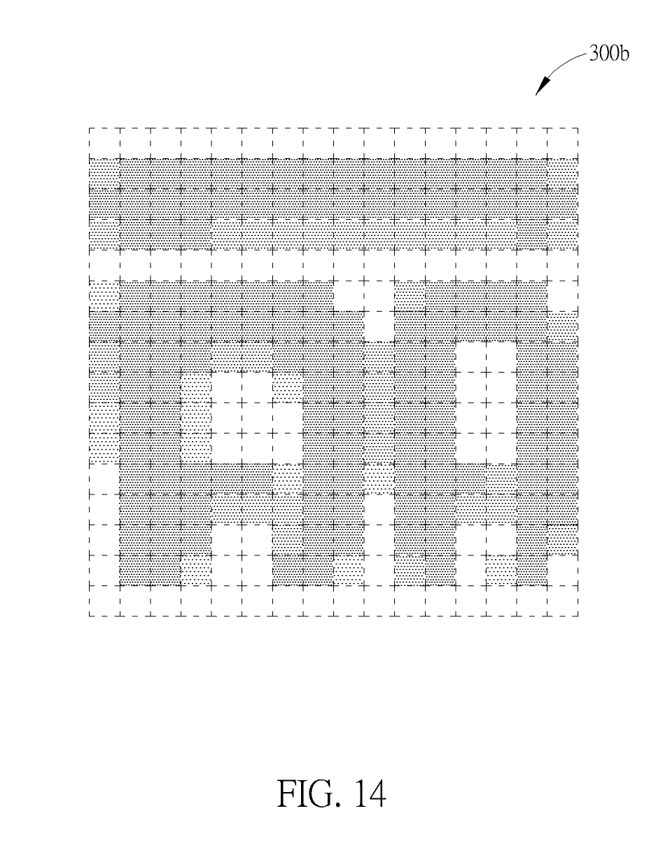

FIG. 13 illustrates an original character 300a according to the third embodiment of the present invention. FIG. 14 illustrates a deformed character 300b according to the third embodiment of the present invention. The deformed character 300b may be obtained by deforming the character 300a. In an example of FIGS. 13-14, the character “ [symbol] ” (corresponding to a Unicode code“U+4E3D”) is only used to illustrate the method provided by the third embodiment instead of limiting the scope of the present invention. The character 300a may be different from the characters 100a and 200a because the character 300a may be of a bitmap font and composed of a set of bitmap pixels rather than being defined with an outline or a set of strokes. Each bitmap pixel may have a grey-level value such as a value between 0 (black) to 255 (white). In another embodiment, each bitmap pixel may be black or white. In FIGS. 13-14, using a frame to surround the character 300a, using a set of first partitioning lines and a set of second partitioning lines to divide the frame into a plurality of partitions, and moving the set of first partitioning lines and/or the set of second partitioning lines to change dimensions of some partitions so as to deform the character 300a and obtain the character 300b may be operated in the similar manner as the first and second embodiments of the present invention described above. Hence, the related operation is not described repeatedly. However, according to the third embodiment, the coordinates of each bitmap pixel in its corresponding partition should be kept unchanged substantially.

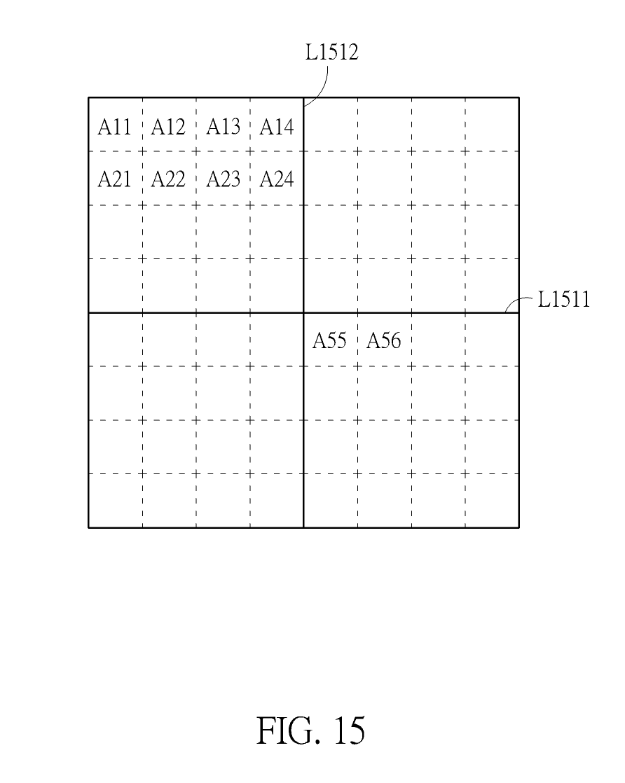

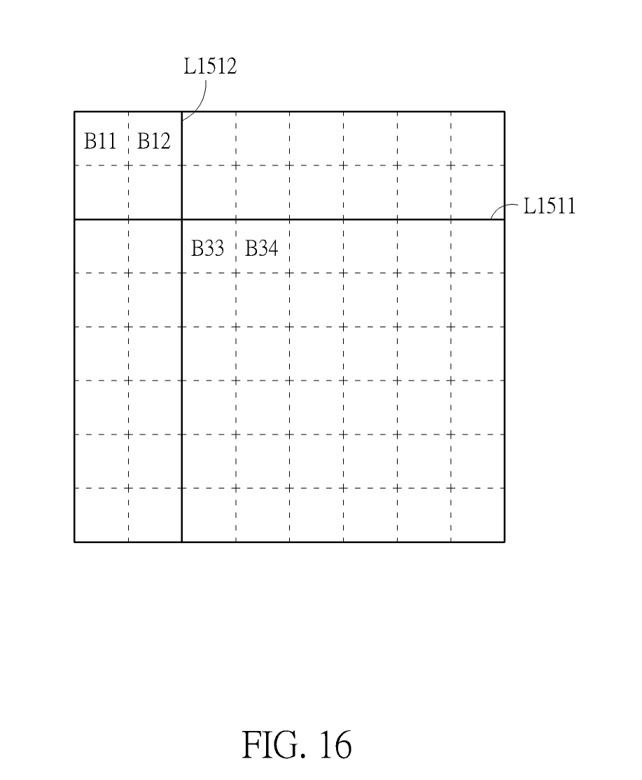

FIGS. 15-16 illustrate adjustment of grey-level values of bitmap pixels of a deformed character according to the third embodiment of the present invention. When a character disposed in FIG. 15 is deformed to be disposed in FIG. 16, a first partitioning line L1511 may be moved upward, and a second partitioning line L1512 may be moved leftward. Hence, the relationship of bitmap pixels before and after deforming the character may be described in table-4.

TABLE 4

| | The corresponding bitmap |
|---|---|
| The bitmap pixels of an undeformed | pixels of a deformed |
| character | character |
| (FIG. 15) | (FIG. 16) |
| bitmap pixels A11, A12, A13 and A14 | bitmap pixel B11 |
| bitmap pixels A13, A14, A15 and A16 | bitmap pixel B12 |
| the left two-thirds of the bitmap | bitmap pixel B33 |
| pixel A55 | |
| the right one third of the bitmap | bitmap pixel B34 |
| pixel A55, and the left one third of | |
| the bitmap pixel A56 | |

Hence, the grey-level values of bitmap pixels of a deformed character may be calculated by using the grey-level value(s) of at least one corresponding bitmap pixel of an undeformed character. If grey-level values GA11 to GA16, GA55, GA56, GB11, GB12, GB33 and GB34 stand for grey-level values of the bitmap pixels A11 to A16, A55, A56, B11, B12, B33 and B34 respectively, the grey-level values of bitmap pixels of the deformed character may be calculated by using the equations (cal-1) to (cal-4):

GB11=(GA11+GA12+GA21+G A22)/4 (cal-1);

GB12=(GA13+GA14+GA23+GA24)/4 (cal-2);

GB33=GA55 (cal-3);

and

GB34=(GA55+GA56)/2 (cal-4).

The adjustment of grey-level value described above may be merely an example to provide an approach of obtaining the bitmap pixel grey-level values of a deformed character. Other reasonable calculation functions may be used to adjust grey-level values according to other embodiments of the present invention.

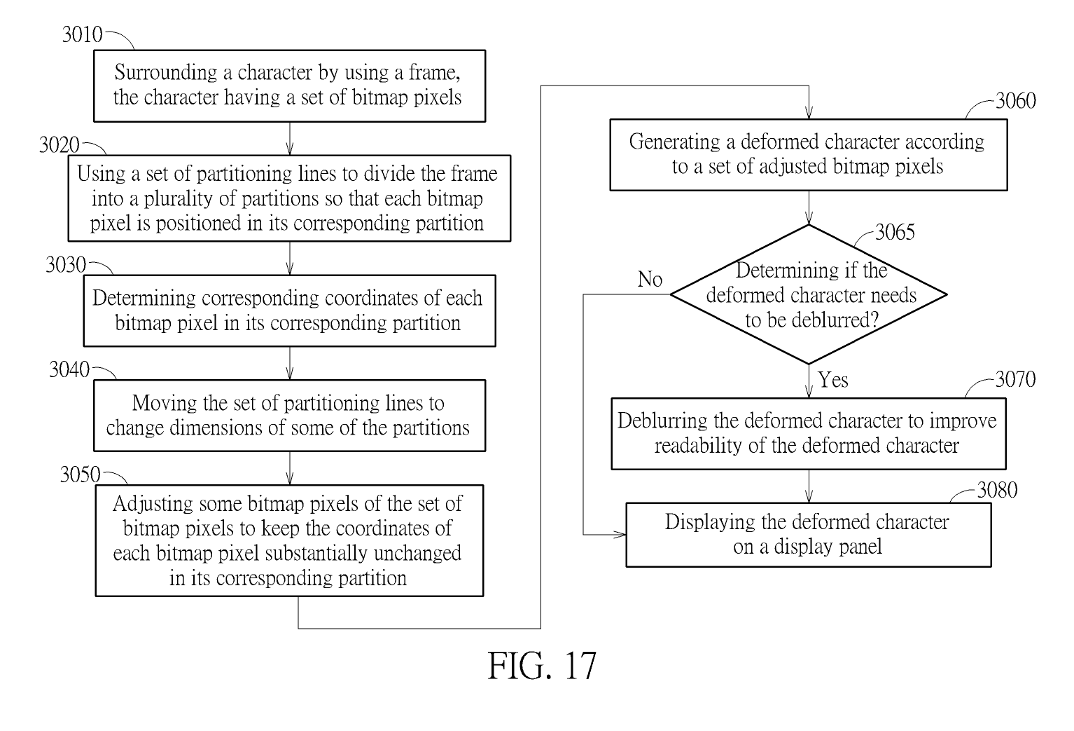

FIG. 17 illustrates a flowchart of a font deformation method 3000 according to the third embodiment of the present invention. The method 3000 may include the following steps:

Step 3010: surrounding a character by using a frame, the character having a set of bitmap pixels;

Step 3020: using a set of partitioning lines to divide the frame into a plurality of partitions so that each bitmap pixel is positioned in its corresponding partition;

Step 3030: determining corresponding coordinates of each bitmap pixel in its corresponding partition;

Step 3040: moving the set of partitioning lines to change dimensions of some of the partitions;

Step 3050: adjusting some bitmap pixels of the set of bitmap pixels to keep the coordinates of each bitmap pixel substantially unchanged in its corresponding partition;

Step 3060: generating a deformed character according to a set of adjusted bitmap pixels; and

Step 3065: determining if the deformed character needs to be deblurred; if so, entering step 3070; if not, entering step 3080;

Step 3070: deblurring the deformed character to improve readability of the deformed character; and

Step 3080: displaying the deformed character on a display panel.

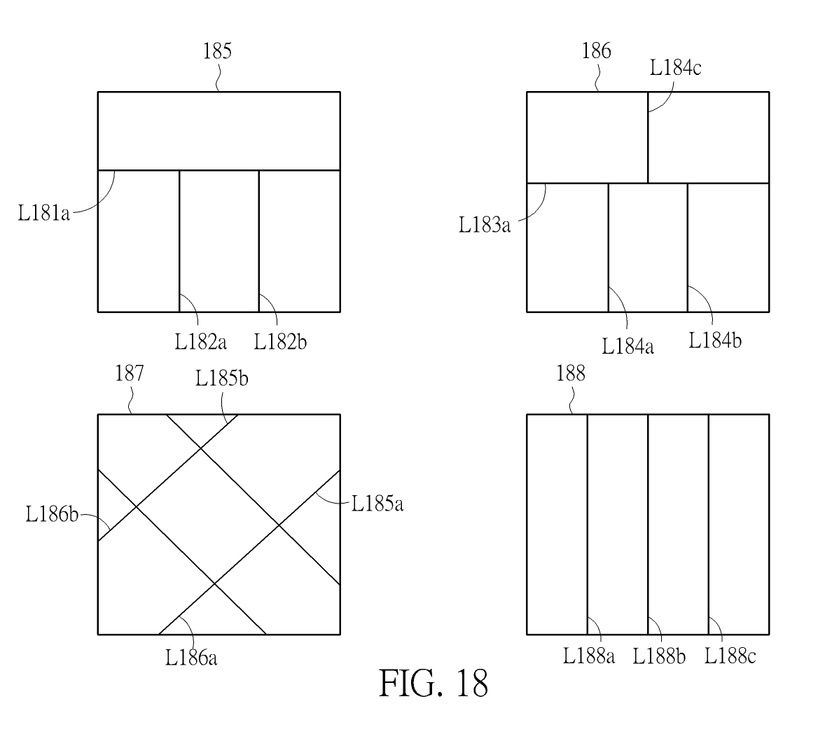

According to the above description, font deformation methods disclosed by embodiments of the present invention may apply to vector fonts, stroke-based fonts and bitmap fonts. FIG. 18 illustrates four plans of partitions and partitioning lines as examples according to embodiments of the present invention. For example, partitioning lines used to divide a frame may include a set of first partitioning lines and a set of second partitioning lines. The set of first partitioning lines may be disposed along a first direction, and the set of second partitioning lines may be disposed along a second direction different from the first direction. In addition to the checkerboard plan illustrated in FIGS. 4-5, partitions in a frame may be planned as examples shown in FIG. 18. In FIG. 18, a frame 185 may be divided into a plurality of partitions by a first partitioning line L181a and two second partitioning lines L182a and L182b. Another frame 186 may be divided into a plurality of partitions by a first partitioning line L183a and three second partitioning lines L184a, L184b and L184c. Yet another frame 187 may be divided into a plurality of partitions by two first partitioning lines L185a and L185b, and two second partitioning lines L186a and L186b. Yet another frame 188 may be divided into a plurality of partitions by three partitioning lines L188a, L188b and L188c. The plans of the partitioning lines and partitions as examples shown in plans in FIG. 18 are examples instead of limiting the scope of the present invention. Dimensions and shape of a frame surrounding a character may be adjusted after the character is deformed according to a user's requirement. Moreover after deforming a character, the sizes of different portions of the character will change according to the changes of the shapes and dimensions of the partitions in the frame.

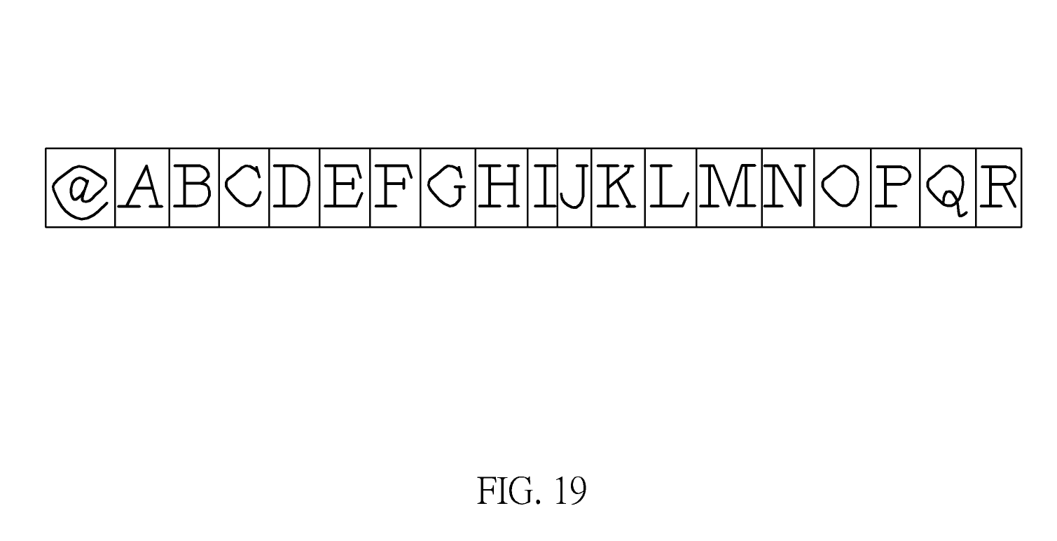

FIG. 19 illustrates visual effects of deforming a set of Latin characters according to an embodiment of the present invention. After deforming a character including a higher ratio of curved stroke such as a Latin character by using a method provided by the present invention, the portion of the curved stroke may become irregular. For example, a curved stroke may be wavy or even jagged as shown in FIG. 19 after being deformed. The wavy or jagged deformed strokes may be kept and regarded as a special visual effect by a font designer. When a font designer wants to smoothen a curved stroke of a deformed character, the Bezier curve algorithm may be used. According to an often used Bezier curve algorithm, a wavy or jagged stroke may be smoothened by tracking an intermediate on-curve point along with a reference segment formed by two points out of the resulted Bezier curve. According to other embodiments of the present invention, other algorithms in addition to Bezier curve algorithm and/or manual adjustment may be used to smoothen a wavy or jagged stroke of a deformed character.

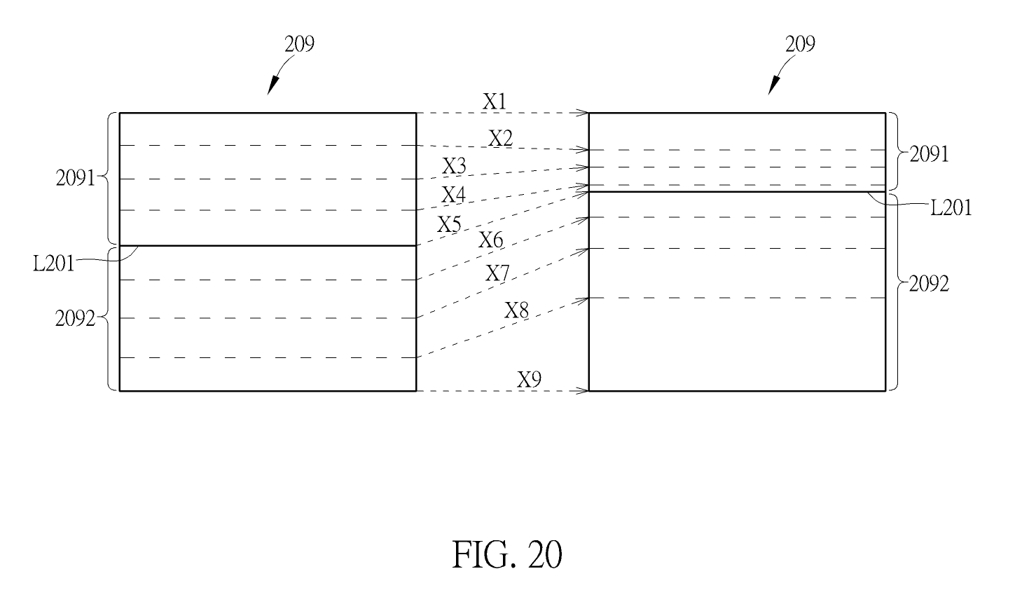

According to an embodiment of the present invention, a coordinate system in a partition for locating control points, key points or strokes of a character may be set asymmetric. A stroke or a portion of a deformed character closed to a boundary between two partitions may be made smoother when using an asymmetric coordinate system. FIG. 20 illustrates an approach to set asymmetric coordinate systems in partitions according to an embodiment of the present invention. A frame 209 may be divided by a partitioning line L201 into two partitions 2091 and 2092. When the partitioning line L201 is moved upward, the partition 2091 may be narrowed vertically so as to become flatter, and the partition 2092 may be widened vertically. The coordinate systems used in the deformed partitions 2091 and 2092 may be set by referring to auxiliary lines such as X1 to X9 shown in FIG. 20. As shown in FIG. 20, a set of horizontal lines of an original coordinate system (in the left frame 209 of FIG. 20) may be arranged evenly with an identical spacing. However, in an adjusted coordinate system set in a frame surrounding a deformed character such as the right frame 209 of FIG. 20, the corresponding set of horizontal lines may be arranged more densely when being closer to the partitioning line L201 and less densely when being further from the partitioning line L201. That is to say, the spacing between two horizontal lines of the adjusted coordinate system of a deformed character may be smaller when the two horizontal lines are closer to the boundary of the two partitions 2091, 2092. By adjusting the coordinate to be asymmetric, the deformation of the character may be made smoother to avoid a sharp transition at the boundary of the two partitions 2091, 2092. The approach provided in FIG. 20 is merely an example. Another appropriate approach and arrangement may be used to set an asymmetric coordinate system in a frame surrounding a deformed character according to another embodiment of the present invention.

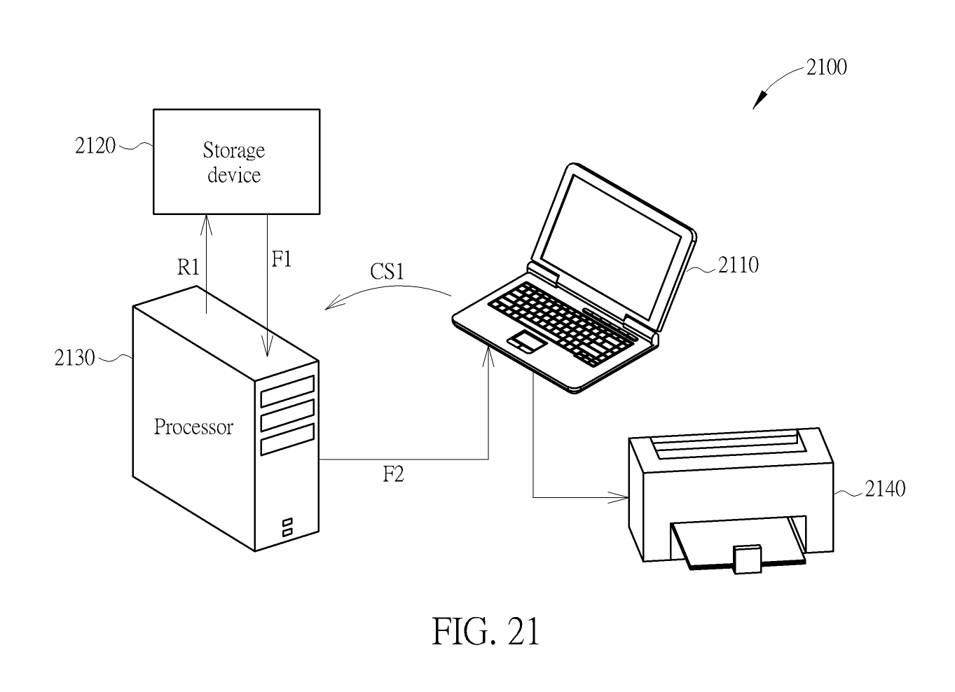

FIG. 21 illustrates a system 2100 corresponding to a font deformation method provided by an embodiment of the present invention. The system 2100 may include an input/output (I/O) device 2110, a storage device 2120 and a processor 2130. The input/output (I/O) device 2110 may be a device for a user to operate such as a keyboard or a display. The storage device may be a memory device such as a flash memory device or a hard disk drive device. The processor 2130 may include graphics processing unit (GPU) and/or a font engine. In the system 2100, a user may send a control instruction CS1 to the processor 2130 to trigger the processor 2130 to send a corresponding request R1 to the storage device 2120. The storage device 2120 may send back an undeformed character F1 to the processor 2130 correspondingly. A processing unit and/or a font engine of the processor 2130 may perform a font deformation method according to an embodiment of the present invention so as to deform the character F1 and generate a deformed character F2. The deformed character F2 may be sent to the input/output device 2110. For example, the deformed character F2 may be displayed when the input/output device 2110 is a display panel. According to another embodiment, the input/output device 2110 may be coupled to a printer 2140 to print out the deformed character F2.

Less storage space for storing font(s) may be required by using font deformation method of the present invention. For example, when storing 500 fonts, and each font has an estimated file size of 5 MB (megabyte), a flash memory larger than 500 MB is required without using a method of the present invention. However, by using a method of an embodiment of the present invention, one font may be deformed to generate 100 fonts. Hence, the required storage space may be reduced by 99% such as from 500 MB to 5 MB. In another example, when a font design team develops a new font, thousands or even tens of thousands of characters in the font may be deformed automatically by using a font deformation method according to an embodiment of the present invention, and a new font with different artistic effect may be generated quickly. The new font with a set of deformed characters may be used directly, for example, to be displayed or printed out, or be adjusted manually. No matter what process or application is applied, research and develop cost and time of developing the new font may be greatly reduced. By using a font deformation method according to an embodiment of the present invention, the number of fonts stored in a font engine at a server terminal (e.g. a cloud host server) or a user terminal (e.g. a smart phone or a personal computer) may be reduced, solving the problems in the art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A font deformation method comprising:
surrounding a character with a frame, wherein an outline of the character has a plurality of control points configured to define the outline of the character;
using a set of partitioning lines to divide the frame into a plurality of partitions, the set of partitioning lines separating the character into a plurality of character portions each being corresponding to a partition;
determining corresponding coordinates of each control point in its corresponding partition;
moving the set of partitioning lines to change dimensions of some of the partitions;
adjusting at least one control point to keep corresponding coordinates of each control point substantially unchanged in its corresponding partition;
drawing a deformed outline according to a plurality of adjusted control points to generate a deformed character; and
displaying the deformed character on a display panel.

2. The font deformation method of claim 1, further comprising:
utilizing a Bezier curve algorithm to fine tune the deformed outline so as to smoothen the deformed outline.

3. The font deformation method of claim 1, wherein the set of partitioning lines comprises a set of first partitioning lines and a set of second partitioning lines, the set of first partitioning lines are disposed along a first direction, the set of second partitioning lines are disposed along a second direction, and the first direction is different from the second direction; and
wherein moving the set of partitioning lines to change the dimensions of some of the partitions is moving the set of first partitioning lines and/or the set of second partitioning lines to change the dimensions of some of the partitions.

4. The font deformation method of claim 1, further comprising:
setting a set of coordinates in the at least one partition of the partitions in an asymmetric manner.

5. A font deformation method comprising:
surrounding a character by using a frame, wherein the character has a set of strokes, and each of the strokes has at least a key point so that the character comprises a set of key points;
using a set of partitioning lines to divide the frame into a plurality of partitions so that each key point is corresponding to a partition;
determining corresponding coordinates of each key point in its corresponding partition;
moving the set of partitioning lines to change dimensions of some of the partitions;
adjusting at least one key point to keep corresponding coordinates of each key point substantially unchanged in its corresponding partition;
drawing a set of adjusted strokes according to the set of adjusted key points;
generating a deformed character according the set of adjusted strokes; and
displaying the deformed character on a display panel.

6. The font deformation method of claim 5, wherein each of the set of strokes corresponds to a stroke identification code and comprises a set of width parameters.

7. The font deformation method of claim 5, wherein the set of partitioning lines comprises a set of first partitioning lines and a set of second partitioning lines, the set of first partitioning lines are disposed along a first direction, the set of second partitioning lines are disposed along a second direction, and the first direction is different from the second direction; and
wherein moving the set of partitioning lines to change the dimensions of some of the partitions is moving the set of first partitioning lines and/or the set of second partitioning lines to change the dimensions of some of the partitions.

8. The font deformation method of claim 5, further comprising:
setting a set of coordinates in some of the partitions in an asymmetric manner.

9. The font deformation method of claim 5, further comprising:
deblurring the deformed character to improve readability of the deformed character.

10. The font deformation method of claim 9, wherein deblurring the deformed character comprises reducing strokes of the deformed character, moving strokes of the deformed character and/or adjusting stroke widths of the deformed character.

11. A font deformation method comprising:
surrounding a character by using a frame, the character having a set of bitmap pixels;
using a set of partitioning lines to divide the frame into a plurality of partitions so that each bitmap pixel is corresponding to a partition;
determining corresponding coordinates of each bitmap pixel in its corresponding partition;
moving the set of partitioning lines to change dimensions of some of the partitions;
adjusting at least one bitmap pixel of the set of bitmap pixels to keep the coordinates of each bitmap pixel substantially unchanged in its corresponding partition;
generating a deformed character according to a set of adjusted bitmap pixels; and
displaying the deformed character on a display panel.

12. The font deformation method of claim 11, wherein each bitmap pixel has a grey-level value, and each adjusted bitmap pixel has an adjusted grey-level value.

13. The font deformation method of claim 11, wherein the set of partitioning lines comprises a set of first partitioning lines and a set of second partitioning lines, the set of first partitioning lines are disposed along a first direction, the set of second partitioning lines are disposed along a second direction, and the first direction is different from the second direction; and
wherein moving the set of partitioning lines to change the dimensions of some of the partitions is moving the set of first partitioning lines and/or the set of second partitioning lines to change the dimensions of some of the partitions.

14. The font deformation method of claim 11, further comprising:
deblurring the deformed character to improve readability of the deformed character.

15. The font deformation method of claim 14, wherein deblurring the deformed character comprises reducing strokes of the deformed character, moving strokes of the deformed character and/or adjusting stroke widths of the deformed character.

16. The font deformation method of claim 11, further comprising:
setting a set of coordinates in some of the partitions in an asymmetric manner.
